(19) United States
(12) Patent Application Publication
(10) Pub. No.: US 2024/0158038 A1
(43) Pub. Date: May 16, 2024

(54) BICYCLE SEATPOST PROTECTORS

(71) Applicant: RAKSTAND, LLC, MONTGOMERY, TX (US)

(72) Inventor: CHRISTOPHER M. HELMRICH, MONTGOMERY, TX (US)

(73) Assignee: RAKSTAND, LLC, MONTGOMERY, TX (US)

(21) Appl. No.: 18/506,931

(22) Filed: Nov. 10, 2023

Related U.S. Application Data
(60) Provisional application No. 63/383,386, filed on Nov. 11, 2022.

(51) Int. Cl. B62J 23/00; B62J 1/08

(52) U.S. Cl. CPC B62J 23/00; B62J 1/08

(57) ABSTRACT

Apparatus suitable for use as a bicycle seatpost protector includes an outer layer of material, such as natural or synthetic leather, and an inner layer of material, such as felt or microfiber. The layers are of equal length and width. The inner and outer layers of material are joined together into a unitary fabric of length L, where the length L is sufficient to cover substantial portions of a seatpost of a bicycle. The outer and inner layers may or may not have fasteners configured to fasten a first major edge of the fabric to a second major edge of the fabric when the fabric is in a rolled form about the bicycle seatpost.

### CROSS-REFERENCE TO RELATED APPLICATIONS

This application is entitled to and claims the benefit of earlier filed provisional application Ser. No. 63/383,386, filed Nov. 11, 2022, under 35 U.S.C. § 119(e), which earlier filed provisional application is incorporated by reference herein in its entirety.

### BACKGROUND INFORMATION

### Technical Field

The present disclosure relates to apparatus and methods in the bicycle or “cycling” fields. More particularly, the present disclosure relates to apparatus useful as protectors for bicycle seatposts. By “bicycle” I mean to include not only two-wheel cycles, but also single-wheel and multi-wheel cycles, motorized and non-motorized.

### Background Art

In my previous patent applications (U.S. provisional patent application No. 63/036,837, filed Jun. 9, 2020, and nonprovisonal patent application number 17340812, filed Jun. 7, 2021), I described safe, robust bicycle stand apparatus allowing standing, storing and working on bicycles that reduce exposure of cyclists to potential injury due to lack of maintenance on bicycles. While marketing these items, I became aware of a further need for protectors for seatposts. Currently, repair stand jaws are outfitted with rubber/synthetic materials that are intended to prevent scratching of metal seatposts/frames when inserted; however, the rubber/synthetic materials material located in the repair jaws breaks down over time and needs periodic replacing. Repair technicians often use a cloth wrap as a precaution because seatposts can be very expensive to replace. Currently, in bicycle repair shops, a repair person uses a microfiber cloth to wrap around the seatpost prior to engaging a clamp which grabs the seatpost to avoid damage to the seatpost by the clamp. Other available products are “guards” designed only to protect seatposts from splashing, rocks, and the like, much like a fender, and do not wrap around the seatpost, and certainly would not be used during repair to protect the seatpost from jaws of a clamp. United States published patent application US20180281883A1 describes such products and provides a good review of existing products, but they all are used for protecting seatposts from mud splashing, not to protect seatposts from jaws of a clamp. Other known products, such as those known under the trade designation Lizard Skins, are neoprene chainstay protectors, however, these products are not meant to be gripped by jaws of a clamp during repair of the bicycle.

Some cyclists spend great sums on their bicycles and equipment. As may be seen, currently available bicycle seatpost protectors and methods of using them may not be adequate for all circumstances, and at worst may result in damage to seatposts of bicycles. There remains a need for more robust bicycle seatpost protectors. The apparatus of the present disclosure are directed to these needs.

### SUMMARY

In accordance with the present disclosure, bicycle seatpost protectors are presented that reduce or overcome many of the shortcomings of previous devices. The seatpost protectors of the present disclosure put control in the hands of the bicycle owner, are preventative and avoid any chance of scratching of seatposts, as it is always wrapped around as a precaution. As noted herein, seatposts can be very expensive to replace. Other advantages of the seatpost protectors of the present disclosure are that they
help prevent movement of the seatpost/frame while bicycle is in the repair stand jaws;
reduces clutter/eyesore; and
makes the seatpost more visible and easier to make adjustments in and around that area of the bicycle without a rag being in the way.

An apparatus suitable for use as a bicycle seatpost protector, comprising:
a) an outer layer of material;
b) an inner layer of material of equal length and width as the outer layer of material;
c) the inner and outer layers of material joined together into a unitary fabric of length L, where the length L is sufficient to cover substantial portions of a seatpost of a bicycle; and
d) the outer and inner layers having fasteners configured to fasten a first major edge of the fabric to a second major edge of the fabric when the fabric is in a rolled form about the bicycle seatpost.

In certain embodiments the outer layer of material may be selected from tough but flexible natural and synthetic materials, such as natural leather, synthetic leather, and the like. In certain other embodiments the outer layer of material may be selected from the group consisting of high density foams, thermoplastic materials, thermoplastic elastomers, and combinations thereof.

In certain embodiments the inner layer of material may be selected from the group consisting of felt, natural or synthetic woven or nonwoven materials, microfiber cloth, pile cloth, and combinations thereof.

In certain embodiments the inner and outer layers of material are joined together with any one of gluing, stitching, meltbonding, or combinations thereof.

In certain embodiments the fasteners configured to fasten a first major edge of the fabric to a second major edge of the fabric when the fabric is in a rolled form about the bicycle seatpost comprise hook and loop fastener strips, which are glued, stitched, meltbonded, or combination thereof to the inner layer of material and the outer layer of material, respectively.

In certain embodiments the length L may range from about 50 to about 100 percent of a length of the seatpost, or from about 75 to about 100 percent of a length of the seatpost.

As used herein “tough” and “flexible”, with respect to the outer layer of material, are understood to mean that the outer layer of material is sufficiently sturdy but pliable to withstand repeated clamping/unclamping by jaws of a repair stand or tool, such as disclosed in my previous patent applications, as well as withstand being hit by rocks, stones, mud, and the like during use while riding the bicycle.

These and other features of the apparatus of this disclosure will become more apparent upon review of the brief description of the drawings, the detailed description, and the claims that follow. It should be understood that wherever the term “comprising” is used herein, other embodiments where the term “comprising” is substituted with “consisting essentially of” are explicitly disclosed herein. It should be further understood that wherever the term “comprising” is used herein, other embodiments where the term “comprising” is substituted with “consisting of” are explicitly disclosed herein. Moreover, the use of negative limitations is specifically contemplated; for example, certain apparatus may comprise a number of physical components and features but may be devoid of certain optional hardware and/or other features. For example, certain seatpost protector embodiments may be devoid of fasteners. An example is the use of expandable material that is able to change dimensions with simple hand force. Such seat post protectors are generally cylindrical, but have a longitudinal slit that expands to an opening or gap substantially equal to the width of the seatpost itself, and the user just slides or presses the seatpost protector over the seatpost/frame without fasteners. Such seatpost protectors may use a synthetic polymeric foam or other material that expands and contracts when pressed on, and held in place once the jaws of a repair tool are clamped down on it. The synthetic foam material may be a closed cell foam, wherein the synthetic foam material is selected from the group consisting of foamed polystyrene, foamed polyurethane, and foamed polyethylene.

### BRIEF DESCRIPTION OF THE DRAWINGS

The manner in which the objectives of this disclosure and other desirable characteristics can be obtained is explained in the following description and attached drawings in which:

FIG. 1 is a schematic perspective view of a bicycle being repaired using a bicycle repair stand having a clamp holding the seatpost of the bicycle;

FIG. 2 is a schematic side elevation view of a bicycle having a seatpost protector thereon according to one embodiment of the present disclosure;

FIG. 3 is a schematic closeup view of the seatpost protector and seatpost of FIG. 2;

FIG. 4 is a schematic perspective view of the seatpost protector of FIGS. 2 and 3 in an unfurled state, with some portions illustrated in phantom;

FIG. 5 is a schematic perspective view of the seatpost protector of FIG. 4 in its rolled state;

FIG. 6 is a schematic cross-section view of the seatpost protector of FIG. 5 taken along the cross-section identified in FIG. 4;

FIG. 7 is a schematic end elevation view of the seatpost protector of FIGS. 4, 5, and 6;

FIG. 8 is a plan view of another seatpost protector embodiment in accordance with the present disclosure; and

FIG. 9 is a schematic perspective view of yet another seatpost protector embodiment in accordance with the present disclosure.

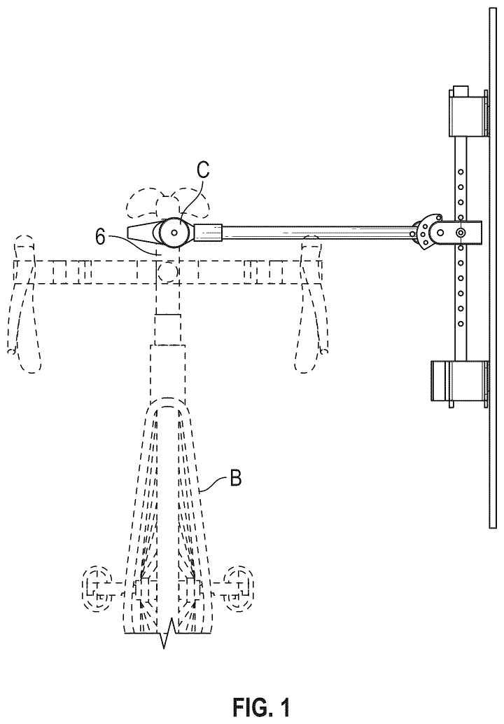

It is to be noted, however, that the appended drawings of FIGS. 1-9 may not be to scale and illustrate only typical apparatus embodiments of this disclosure. Therefore, the drawing figures are not to be considered limiting in scope, for the disclosure may admit to other equally effective embodiments. Identical reference numerals are used throughout the several views for like or similar elements.

### DETAILED DESCRIPTION

In the following description, numerous details are set forth to provide an understanding of the disclosed apparatus, combinations, and methods. However, it will be understood by those skilled in the art that the apparatus, combinations, and methods disclosed herein may be practiced without these details and that numerous variations or modifications from the described embodiments may be possible. All U.S. published patent applications and U.S. patents referenced herein are hereby explicitly incorporated herein by reference, irrespective of the page, paragraph, or section in which they are referenced. Where a range of values describes a parameter, all sub-ranges, point values and endpoints within that range or defining a range are explicitly disclosed herein.

FIG. 1 is a schematic perspective view of a bicycle B being repaired using a bicycle repair rack and stand having a clamp C holding a seatpost 6 of bicycle B, in accordance with my previous patent applications.

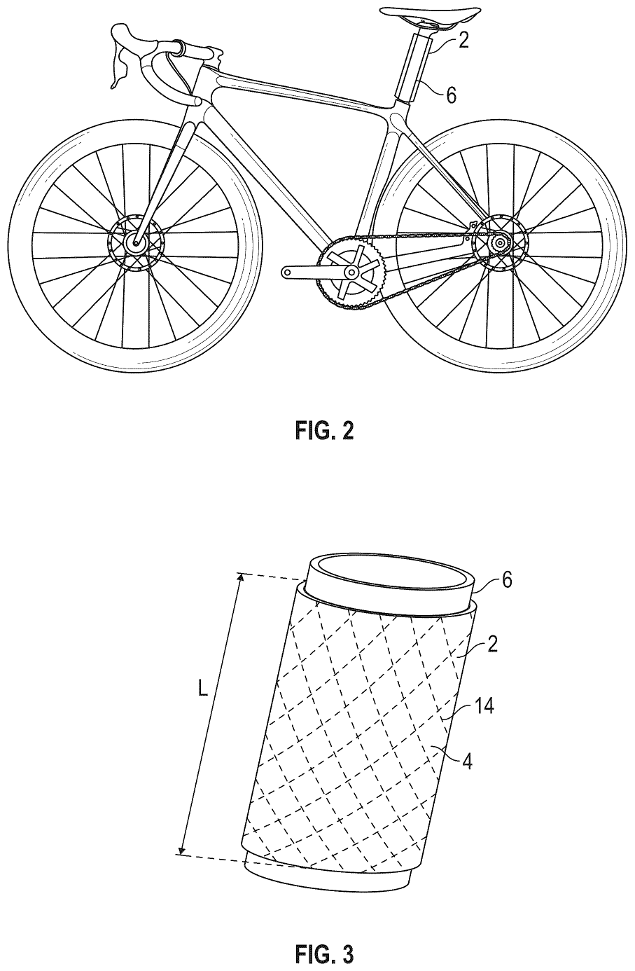

FIG. 2 is a schematic side elevation view of bicycle B having a seatpost protector 2 wrapped around seatpost 6 thereon according to one embodiment of the present disclosure. FIG. 3 is a schematic closeup view of seatpost protector 2 and seatpost 6 of FIG. 2, illustrating the seatpost protector outer layer 4, typically natural or synthetic leather, although other materials may be used, such as, for example, high density foam, thermoplastic materials, thermoplastic elastomers, and the like. Seatpost protector 2 has a length L that may range from about 50 to about 100 percent of a length of the seatpost 6, or from about 75 to about 100 percent of the length of the seatpost.

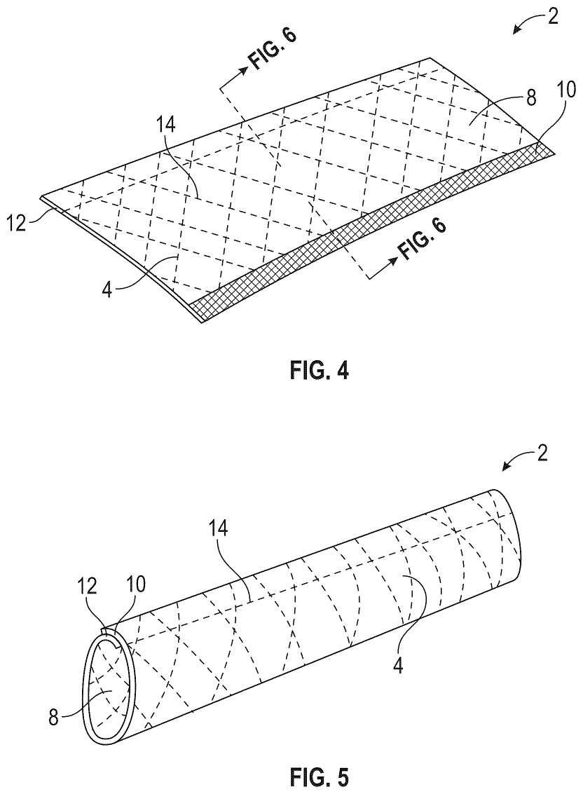

FIG. 4 is a schematic perspective view of seatpost protector 2 of FIGS. 2 and 3 in an unfurled state, with some portions illustrated in phantom, and FIG. 5 is a schematic perspective view of seatpost protector 2 of FIG. 4 in its “rolled” state, illustrating an inner layer 8 that may be felt or other soft material, such as a natural or synthetic woven or nonwoven, or pile cloth. Inner layer 8 and outer layer 4 may be adhered together with glue, stitching 14, meltbonding, or combination thereof. Seat protector 2 also features hook and loop fastener strips 10 and 12, which may be similarly glued, stitched, meltbonded (or combination thereof) to the inner layer 8 and outer layer 4, respectively. In seatpost protector 2 and like embodiments, the fasteners are configured to fasten a first major edge of the fabric to a second major edge of the fabric when the fabric is in a rolled form about the bicycle seatpost, and may comprise comprise hook and loop fastener strips 10, 12, which are glued, stitched, meltbonded, or combination thereof to the inner layer of material and the outer layer of material, respectively.

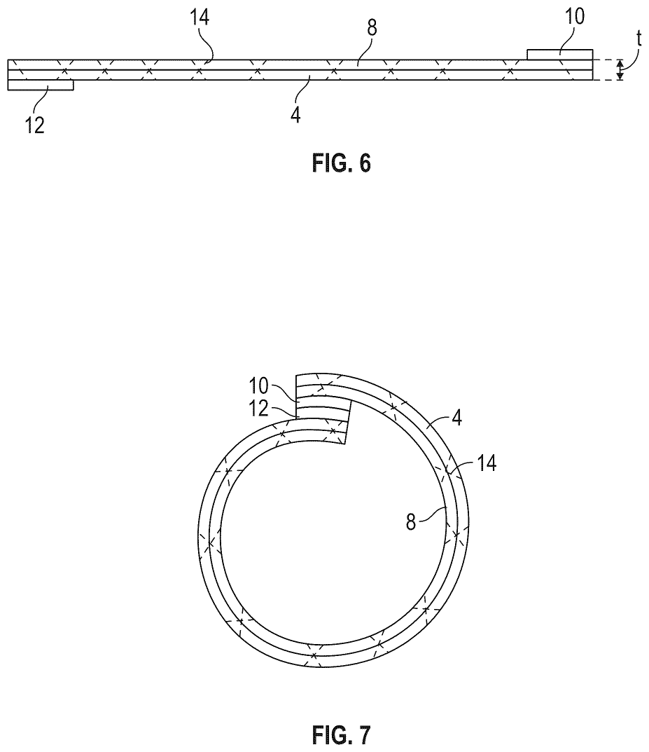

FIG. 6 is a schematic cross-section view of seatpost protector 2 of FIG. 5 taken along the cross-section identified in FIG. 4, and FIG. 7 is a schematic end elevation view of seatpost protector 2 of FIGS. 4, 5, and 6. Seatpost protector 2 has a combined thickness “t” of inner layer 8 and outer layer 4 ranging from about 5 to about 250 mm, or from about 20 to about 200 mm, or from about 50 to about 200 mm.

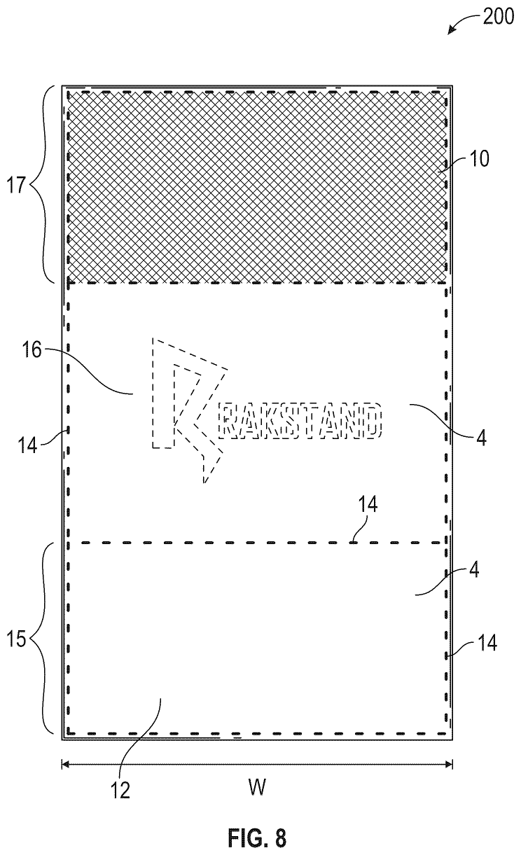

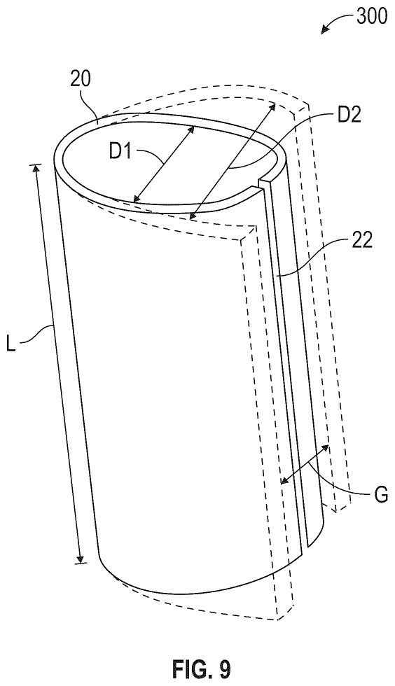

FIG. 8 is a plan view of another seatpost protector embodiment 200 in accordance with the present disclosure. Seatpost protector 200 is similar to seatpost protector 2 in that they both comprise an outer layer and an inner layer. In seatpost protector 200 and like embodiments, the outer layer 4 is leather and inner layer 8 may be felt or other soft material, such as a natural or synthetic woven or nonwoven, or pile cloth. The fasteners are configured to fasten a first minor portion 15 of the fabric to a second minor portion 17 of the fabric when the fabric is in a rolled form about the bicycle seatpost, and may comprise hook and loop fastener strips 10, 12, which are glued, stitched, meltbonded, or combination thereof to the inner layer of material and the outer layer of material, respectively, along a width W. Embodiment 200 also features a different stitching pattern 14 than illustrated in seatpost protector 2 illustrated in FIGS. 2-7. Embodiment 200 has stitching 14 around the perimeter of the fabric, holding the inner and outer layers together. Glue or melt-bonding may be used as well or in place of stitching. There is also stitching for securing the hook and loop fasteners to the fabric. It will be understood that the thread of stitching 14 in any embodiment may be any desired color and pattern. Embodiment 200 further illustrates embossing 16 of outer layer 4.

FIG. 9 is a schematic perspective view of an alternative embodiment 300 in accordance with the present disclosure. Embodiment 300 comprises a member comprising one or more layers of material 20 of cylindrical shape having a length L, where the length L is sufficient to cover substantial portions of a seatpost of a bicycle, an inner diameter D, and a longitudinal slit 22 running the length L. As will be noticed, embodiment 300 is devoid of fasteners. The member is expandable in diameter and able to change dimensions with simple hand force, such that the inner diameter D is expandable from a first value D1 (perhaps 1 to about 3 centimeters) to a second value D2 (illustrated in phantom, perhaps 1.5 to 3 times D1)) and collapsible back to diameter D1 upon removal of the hand force, whereby longitudinal slit 22 is configured to expand to an opening or gap G substantially equal to the width of a seatpost and then collapse back to form longitudinal slit 22 as a user slides or presses the seatpost protector over the seatpost. G may be perhaps about 2 centimeters, or whatever the seatpost diameter is.

In embodiment 300 the one or more layers of material comprises a polymeric foam that contracts from an original shape when pressed upon with hand force and expands back to the original shape once pressure is released. The one or more layers of a flexible, synthetic polymeric material may comprise a foamed polymeric material, such as foamed polystyrene, foamed polyurethane, foamed polyisocyanurate, foamed polyethylene, foamed rubbers, such as foamed polyvinyl chloride/acrylonitrile butadiene (PVC/NBR) rubber, and the like. Preferably the foam is a closed cell foam, which adds the feature of floatation should the seat protector be dislodged during a strenuous trek, over a rocky creek for example. Commercial products, such as the materials known under the trade designations “Ensolite®” and “OleTex®”, both available from RBX Industries, Inc., Roanoke, Va., USA, may find use as members. Products known under the trade designation “Ensolite®” are made in many varieties, but are all essentially variations of PVC/NBR foamed polymers having maximum water absorption of 0.1 lb/ft² when tested using American Society of Testing Materials (ASTM) test D-1667. The products under the OleTex® product line are high-performance, closed cell polyolefin foams, chemically cross-linked using a patented, continuous processing method. The materials are closed cell and moisture proof. These products can be die cut, heat sealed, vacuum formed, and heat molded.

As may be seen, apparatus of the present disclosure may be constructed in several different embodiments.

What has not been recognized or realized is an apparatus that may be used to protect bicycle seatposts from clamping jaws of repair stands. Apparatus to accomplish this without significant cost is highly desirable. As far as I am aware, there exists no device constructed as described herein that can serve as a seatpost protector.

From the foregoing detailed description of specific embodiments, it should be apparent that patentable apparatus are described. Although specific embodiments of the disclosure have been described herein in some detail, this has been done solely for the purposes of describing various features and aspects of the apparatus and is not intended to be limiting with respect to their scope. It is contemplated that various substitutions, alterations, and/or modifications, including but not limited to those implementation variations which may have been suggested herein, may be made to the described embodiments without departing from the scope of the appended claims. For example, one modification would be to replace the hook and loop fasteners with other fasteners, such as snaps, clips and the like, as long as the fasteners do not contribute to damaging the seatpost when installed on the seatpost.

What is claimed is:

1. An apparatus suitable for use as a bicycle seatpost protector, comprising:
a) an outer layer of material;
b) an inner layer of material of equal length and width as the outer layer of material;
c) the inner and outer layers of material joined together into a unitary fabric of length L, where the length L is sufficient to cover substantial portions of a seatpost of a bicycle; and
d) the outer and inner layers having fasteners configured to fasten a first major edge of the fabric to a second major edge of the fabric when the fabric is in a rolled form about the bicycle seatpost.

2. The apparatus of claim 1 wherein the outer layer of material is selected from natural and synthetic materials.

3. The apparatus of claim 2 wherein the outer layer of material is natural leather.

4. The apparatus of claim 2 wherein the outer layer of material is selected from the group consisting of high density foams, thermoplastic materials, thermoplastic elastomers, and combinations thereof.

5. The apparatus of claim 1 wherein the inner layer of material is selected from the group consisting of felt, natural or synthetic woven or nonwoven materials, microfiber cloth, pile cloth, and combinations thereof.

6. The apparatus of claim 1 wherein the inner layer of material and the outer layer of material are joined together with any one of glue, stitching, meltbonding, or combinations thereof.

7. The apparatus of claim 1 wherein the fasteners configured to fasten a first major edge of the fabric to a second major edge of the fabric when the fabric is in a rolled form about the bicycle seatpost comprise hook and loop fastener strips, which are glued, stitched, meltbonded, or combination thereof to the inner layer of material and the outer layer of material, respectively.

8. The apparatus of claim 1 wherein the length L ranges from about 50 to about 100 percent of a length of the seatpost.

9. The apparatus of claim 1 wherein the length L ranges from about 75 to about 100 percent of a length of the seatpost.

10. An apparatus suitable for use as a bicycle seatpost protector, comprising:
a) an outer layer of material;
b) an inner layer of material of equal length and width as the outer layer of material;
c) the inner and outer layers of material joined together into a unitary fabric of length L and width W, where the width W is sufficient to cover substantial portions of a seatpost of a bicycle; and
d) the outer and inner layers having fasteners configured to fasten a first minor portion of the fabric to a second minor portion of the fabric when the fabric is in a rolled form about the bicycle seatpost.

11. An apparatus suitable for use as a bicycle seatpost protector, comprising:
a member comprising one or more layers of material of cylindrical shape, having a length L, where the length L is sufficient to cover substantial portions of a seatpost of a bicycle, an inner diameter D, and comprising a longitudinal slit running the length L;
the member devoid of fasteners; and
the member being expandable in diameter and able to change dimensions with simple hand force, such that the inner diameter D is expandable from a first value D1 to a second value D2 and collapsible back to diameter D1 upon removal of the hand force, whereby the longitudinal slit is configured to expand to an opening or gap substantially equal to the width of a seatpost and then collapse back to form the longitudinal slit as a user slides or presses the seatpost protector over the seatpost.

12. The apparatus of claim 11 wherein the one or more layers of material comprises a polymeric foam that contracts from an original shape when pressed on and expands back to the original shape once pressure is released.
